(19) United States
(12) Patent Application Publication
(10) Pub. No.: US 2007/0183703 A1
(43) Pub. Date: Aug. 9, 2007

(54) Rolling bearing having a nickel-phosphorus coating

(75) Inventors: David R. Mikalonis, Royersford, PA (US); Hans Wallin, Lansdale, PA (US); Hubert Koettrisch, Amstetten (AT); Rutgerus Simon Heemskerk, Kuetzberg (DE); Xiao Bo Zhou, Houten (NL)

Correspondence Address: BUCHANAN, INGERSOLL & ROONEY PC, POST OFFICE BOX 1404, ALEXANDRIA, VA, 22313-1404, US

(73) Assignee: AB SKF, Goteborg (SE)

(21) Appl. No.: 10/583,350

(22) PCT Filed: Dec. 20, 2004
(86) PCT No.: PCT/NL04/00890

§ 371 Date: Oct. 19, 2006

(30) Foreign Application Priority Data
Dec. 19, 2003 (NL) 1025088

(51) Int. Cl. F16C 33/62

(52) U.S. Cl. 384/492

(57) ABSTRACT

Rolling bearing comprising at least one ring with raceway and rolling elements. To increase resistance against failure in an environment containing hydrogen disulphide the related part of the rolling bearing is coated with a nickel-phosphorus coating.

The present invention relates to a rolling bearing according to the preamble of claim 1.

Such a rolling bearing is known from the article of A. Yoshida, M. Fujii, Tribology International, part 35, no. 12, 2002, pages 837-847.

In this article a method is disclosed for improving the tribological performance of machine elements. A comparison is made between electroless provided Ni—P alloy plating and a suffer rising treatment. It is indicated that when using Ni—P at around 106 failure could be observed.

Because this is unacceptable for many applications of rolling bearings the invention aims to improve the properties of rolling bearings. A special application for such rolling bearings is the use in the oil industry. Bearings are used for compressors and other handling equipment of oil products. Such oil products such as natural gas can comprise hydrogen disulphide. If depletion of a gas field is near, the percentage hydrogen disulphide might be considerable. It has been found that under such circumstances rolling bearings experience premature failure due to the presence of hydrogen disulphide in oil lubricating such bearings. Such bearings can comprise roller bearings as well as angular contact ball bearings. However, it should be understood that the invention is not restricted to such bearings and the application thereof in the oil industry. Also in other environments premature failure probably due to stress corrosion cracks has been observed. An example is water contaminated lubrication.

It has been observed that two modes of premature failure occur.

The first type of failure is attack of the surface of the related part of the bearing which can be either a ring or a rolling element. Cracks are initiated at the surface and propagate into the material of the bearing. In surface cracks high sulphur content has been measured resulting in brittle cracks. Because of the presence of sulphur it is assumed that such cracks were the result of a hydrogen disulphide attack. This is a typical stress-corrosion cracking failure.

Another mechanism which has been observed are in subsurface initiated cracks which can lead to spalling of a material and more particular the inner ring raceway. Subsurface crack initiation and propagation has been observed around nucleation of manganese sulphide. This directs in the presence of hydrogen because of hydrogen embrittlement.

Due to the presence of hydrogen disulphide, which decomposes to sulphur and hydrogen on the one hand sulphur will be deposited at the surface of the components of the rolling bearing whilst on the other hand hydrogen atoms can penetrate deeply into the steel with a preferential nucleation of brittle cracks around the manganese sulphide inclusions.

It has been shown that the combination of considerable stress and the presence of hydrogendisulphide could lead to premature failure. It seems that the cage made of brass or steel, of rolling bearings is not sensitive to hydrogen disulphide attack as the cage is not heavily loaded. Normally, such cage is produced from brass.

The invention aims to provide rolling bearing components which are easily and relative cheap to produce and have increased resistance against failure due to hydrogen disulphide presence during considerable loading of the bearing.

According to the invention this aim is realized with the characterizing features of claim 1. It has been found that by increasing the phosphorous content to at least 9% and preferable up to at least 11% by wt and more preferable between 11 and 13% by wt substantially increased service life might be expected.

This might be due to the fact that at lower percentages of phosphor the nickel-phosphor coating applied is in tensile stress on the substrate, whilst at higher phosphor percentages the coating is in a compressive condition on the substrate. This results in better corrosion resisting properties. However, it should be emphasised that this is a theoretic consideration and the validity of the claims is not dependent there from.

According to a further preferred embodiment of the invention service life of the rolling bearing components is considerably increased if before applying the nickel-phosphorous coating a striking-layer is provided improving adhesion of the later nickel-phosphorous coating. More particular this striking-layer is electrolytically applied and comprises a nickel-layer. However, this nickel-layer can also be provided in other ways on the substrate. The thickness of such striking-layer is preferably smaller than 1 μm and more particular smaller than 0.5 μm.

Furthermore the thickness of the nickel-phosphorous-layer is according to a preferred embodiment of the inventor larger than 8 μm and more particular about 15 μm. In this way diffusion of hydrogen is effectively blocked, further increasing the service life of subject rolling bearing.

Surprisingly is has been found that if the above coating is used under dynamic conditions, sufficient resistance against hydrogen disulphide is obtained.

This is remarkable. Other coatings are generally known in the art and it has been found that such coatings do not function. For example investigations have been conducted on zinc coatings, zinc-nickel coating, chromium and thin dense chromium coating, tin coatings, bismuth coatings as well as nickel coatings. No one of these coatings which do function properly under static conditions, gave the desired result as obtained by subject application.

According to a preferred embodiment of the invention, the coating comprises at least 70% by wt. nickel and at least 3-20% by wt. phosphorus. The thickness of the coating is preferably between 2-30 μm and more particular between 10-20 μm and more preferably about 15 μm. The ball bearing steel can comprise any steel but has been found that if, apart from the presence of hydrogen disulphide, an ordinary ball bearing steel comprising 1% by wt. C and 1.5% by wt. Cr and balance Fe is sufficient for an application, the same steel is also sufficient for such application where a coating according to the invention is provided on the rolling bearing elements.

However it should be understood that other usual ball bearing steels can be used such as carburised low/medium carbon steel.

The bearing ring or rolling elements treated according to subject invention can be combined with special purpose rolling elements such as silicon nitride balls or rollers, or diamond-like-carbon coated balls or rollers, to optimise the bearing performance in some application conditions.

The invention also relates to a method for producing a rolling bearing comprising at least one ring provided with raceway and rolling elements to engage said raceway, wherein said ring and raceway comprise a ball bearing steel, wherein said ring and/or rolling elements are coated with a nickel-phosphorus coating.

According to a preferred embodiment of this method as starting point components of the standard rolling bearing produced from a standard ball bearing steel are used. After calculating the increase in size because of the future deposition of a nickel-phosphor coating, the related component or components are machined such that a smaller dimension is obtained and after that the coating is provided. If a through hardening ball bearing steel is used, machining of the related component is not critical for the surface properties. Before coating usual steps have to be taken to make the coating as successful as possible for example by precleaning.

According to a preferred embodiment of the method, the nickel phosphorus coating is provided by elektroless plating i.e. chemical deposition. If parts of a ring are coated, this ring can be statically suspended in a bath. If rolling elements have to be coated preferably they are thumbled into a barrel so that coating from all sides is possible resulting in an even layer on the object to be coated. Generally methods for providing a nickel phosphorus coating are known in the art. Applications known in the art are automotive and industrial components such as fuel components and further applications. Except from precleaning of the steel material on which the coating is deposited according to a preferred embodiment after deposition backing is used. Several companies both in the Netherlands and abroad are able to deposit nickel-phosphorus from a chemical bath.

Generally after coating a smooth surface is obtained which is immediately suitable for the use in rolling bearing purposes which means that after coating the next step is to assembly the several components to obtain a rolling bearing.

The invention will be further elucidated referring to an example.

### EXAMPLE I

A high carbon (1% by wt. C) steel was immersed in a solution to obtain a nickel phosphorus coating. Because of adhesion problems the related components were subjected to an electrolytic etching treatment and a nickel strike was then used prior to the deposition of the nickel phosphorus coating. It has been found that this resulted in improved adhesion of the nickel phosphorus coating. The coating solution comprises a commercial nickel-phosphorus coating containing 10-14 wt. %, 9-12 wt. % and 3-7 wt. % phosphorus respectively. It has been found that a component treated with such coating had the highest corrosion resistance and is recommended for use in pump houses and stop cocks for natural gas and crude oil environment. After providing the coating, the micro hardness of the coatings was measured in Vickers at a low load of 0.2 kg to avoid any influence of the steel substrate. The hardness was sufficient for normal use of rolling bearings at about HV 500-720. A lower phosphorus content increases the hardness.

Scratch test (adhesion critical load test) does not reveal any problems. The same applies to the dry sliding friction measurement. During a rolling contact fatigue test, where a coated bar is loaded by two rotating uncoated steel discs, a maximum contact pressure of 2500 MPa and a speed of 10000 revolutions per minute were conducted. This contact pressure is much higher than under normal application. No failure was observed after 24 hours of test.

Also the salt spray-corrosion test did not give any indication of failure to be expected. The contact stress of the nickel phosphorus coating was calculated by using the multi-grid method. Flaking under rolling contact is not probably to occur.

From the above considerations it is clear the nickel phosphorus coating can be used in dynamically loaded components of rolling bearings in environments wherein hydrogen disulphide is present.

After reading the above description a person skilled in the art will immediately conclude that further (pre of after) treatment are possible during coating resulting in even more improved properties of rolling bearings components. Such additional steps ware within the range of the person skilled in the art and within the range of the appended claims.

1. Rolling bearing comprising at least one ring provided with raceway and rolling elements to engage said raceways, wherein said ring and raceway comprise a ball bearing steel, said ring and/or rolling elements having a nickel-phosphorus coating characterized in that said coating comprising at least 9% by wt phosphorous.

2. Rolling bearing according to claim 1, wherein said coating comprises at least 70% by wt. Ni and 9-20% by wt. phosphorus.

3. Rolling bearing according to claim 1, wherein between said bearing steel and the coating an adhesion a layer is provided.

4. Rolling bearing according to claim 3, wherein said layer comprises a nickel-layer.

5. Rolling bearing according to claim 4, wherein said layer has a thickness smaller than 1 μm.

6. Rolling bearing according to claim 1, wherein said coating has a thickness between 2-30 μm.

7. Rolling bearing according to claim 1, wherein said ball bearing steel comprises about 1% by wt. C, 1.5% by wt. Cr and balance Fe.

8. Rolling bearing according to claim 1, wherein an outer surface of the rolling elements comprises a ceramic material.

9. Rolling bearing according to claim 1, wherein an outer surface of the rolling elements comprises a low friction coating.

10. Method for producing a rolling bearing comprising at least one ring provided with raceway and rolling element to engage said raceway, wherein said ring and raceway comprise a ball bearing steel, wherein said ring and/or rolling elements are coated with a nickel-phosphorus coating, and before coating said elements a striking-layer is provided.

11. Method according to claim 10, wherein said striking-layer is electrolytically applied to said elements.

12. Method according to claim 10, wherein said ring and/or rolling element are produced from ball bearing steel and after hardening and possibly finishing are subjected to a machining step wherein about the same amount of material is removed as is deposited during subsequent depositing of the nickel-phosphorus coating.

13. Method according to claim 10, wherein said coating comprises chemical deposition.

14. Method according to claim 10, wherein the rolling elements are coated and said coating comprises moving of said elements in a bath during coating.

15. Method according to claim 10, wherein after coating the rolling elements and ring are directly assembled.

16. Rolling bearing according to claim 1, wherein said coating has a thickness between 10-20 μm.

17. Rolling bearing according to claim 1, wherein said coating has a thickness of about 15 μm.
